(19) United States
(12) Patent Application Publication
(10) Pub. No.: US 2010/0206495 A1
(43) Pub. Date: Aug. 19, 2010

(54) Roman Curtain Device

(76) Inventor: Ya-Ying Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/371,973

(22) Filed: Feb. 17, 2009

(51) Int. Cl. E06B 9/56

(52) U.S. Cl. 160/332

(57) ABSTRACT

A Roman curtain device has an inner layer, an outer layer and multiple bridging pieces attached between the inner layer and the outer layer. Each of the multiple bridging pieces has multiple through holes to allow two drawing strings from a clutching device on an upper rail penetrating the aligning through holes on different multiple bridging pieces to pull up the curtain. Thereby, the Roman curtain device has the drawing strings covered inside to avoid danger caused by exposure of the drawing strings.

### BACKGROUND OF THE INVENTION

1. Field of the Invention

The present invention relates to a Roman curtain device, and more particularly to a Roman curtain device that accommodates multiple drawing strings inside to keep operation stable and to avoid accident of strapping neck to children caused by exposing the drawing strings.

2. Description of Related Art

Because a Roman curtain has an operational feature to fold by layers, its appearance has sensation of stereoscopic layering and luxury and thus the Roman curtain is popular in the market.

A conventional Roman curtain device 4 as shown in FIG. 4 is designed to mainly have a pulling string 5 winding on a transmission device 61 of an upper rail 5 to service as a drawing string 51 passing through loops 71 (as rings) mounted behind the curtain fabric 7 and secured its end to a bottommost loop 71 of the curtain fabric 7. Therefore, the curtain fabric 7 is folded from its bottom and lifted up by the drawing string 51 when the pulling string 5 is pulled down. When the curtain fabric 7 is pulled upward, the loops 71 abut with each other and each section of the curtain fabric 7 is folded to perform stacked blades. Thus, distance between two adjacent loops decides the size of the folded section.

Although the conventional Roman curtain device is easy to be operated, it has some doubts in safety because the drawing string 51 is exposed and thus might be drawn out from the curtain fabric 71 to cause dangerous situation such as neck-strapping for kids playing around the curtain fabric 7 in household.

### SUMMARY OF THE INVENTION

A main objective of the present invention is to provide a Roman curtain device that is safe in use.

To achieve the foregoing objective, the Roman curtain device comprises at least two pulling strings contacting and passing a clutching device on an upper rail to extend downward to engage with a curtain structure to serve as drawing strings, wherein the improvement of the is that:

the curtain structure is composed of an inner layer and an outer layer, and multiple bridging pieces with at least one through hole connecting between the inner layer and the outer layer.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional side view of a Roman curtain device in accordance with the present invention;

FIG. 2 is a perspective view of the Roman curtain device in FIG. 1;

FIG. 3 is a perspective view of the Roman curtain device with additional enhancing rings in accordance with the present invention; and

FIG. 4 is a perspective view of a conventional Roman curtain device in accordance with prior art.

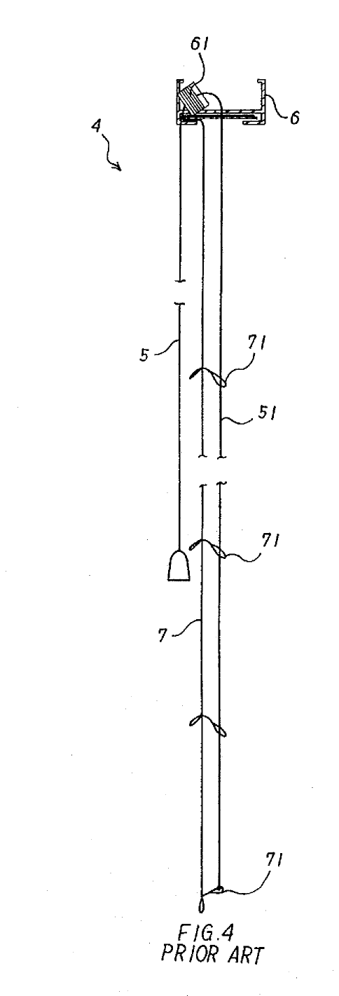

### DETAILED DESCRIPTION OF THE PREFERRED EMBODIMENT

A Roman curtain device in accordance with the present invention is composed of an inner layer, an outer layer and multiple bridging pieces attached between the inner layer and the outer layer. Each of the multiple bridging pieces has multiple through holes to allow at least two drawing strings from a clutching device on an upper rail penetrating the corresponding through holes on different multiple bridging pieces aligning with each other to pull up the curtain. Thereby, the Roman curtain device has the drawing strings covered inside to avoid danger caused by exposure of the drawing strings.

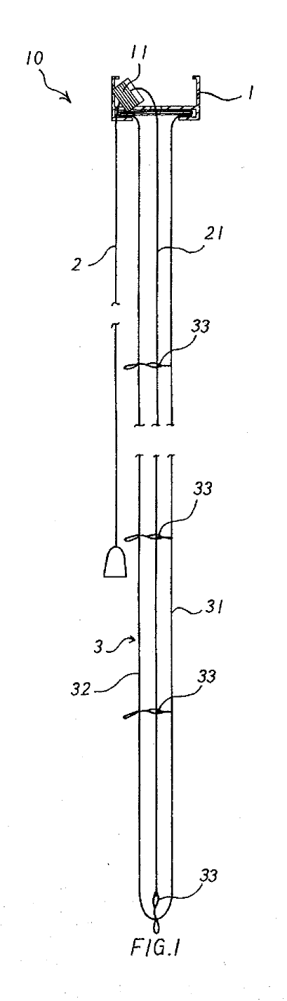

As shown in FIG. 1, a preferred embodiment of Roman curtain device 10 has two pulling strings 2 contacting and passing a clutching device 11 (the clutching device 11 is a conventional device and operationally controls the fastening or looseness of the pulling strings 2 by pulling rightward or leftward) of an upper rail 1 to extend downward to engage a curtain structure 3 dragging down from the upper rail 1 and carry the weight of the curtain structure 3.

The curtain structure 3 is composed of an inner layer 31 and an outer layer 32 arranged in parallel and multiple bridging pieces made of elongated strips 34 connecting between the inner layer and the outer layer 32. Each of the multiple elongated strips 34 has two through holes 33 at two ends to allow the two drawing strings 21 penetrating correspondingly thereby.

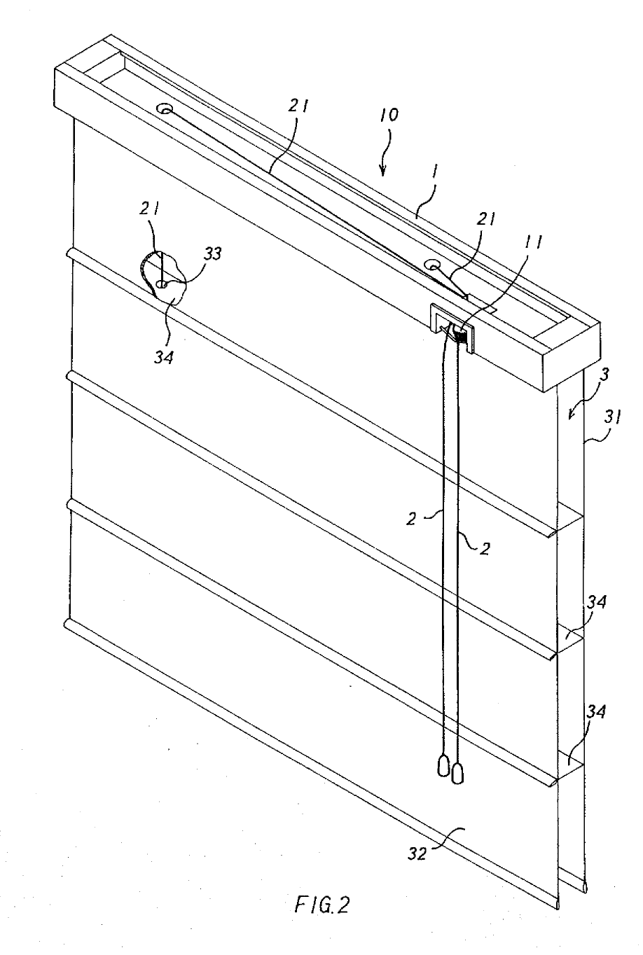

By constructing above components, the drawing strings 21 pass the through holes 33 of the bridging pieces in sequence from upside to downside to be parallel with each other and is secured to the bottommost elongated strip 34 so that the drawing strings 21 are enclosed by the inner layer 31 and the outer layer 32 (as shown in FIG. 2).

When the Roman curtain device is operated, the pulling strips 2 are hold and pulled leftward simultaneously and synchronous to make the clutching device 11 to loosen the pulling strips 2 and then pulled downward to draw out the drawing strings 21. Thus, the drawing strings 21 inside the curtain structure 3 are shortened to pull the curtain structure 3 to get close from its bottom. Until the elongated strips 34 are drawn close by the drawing strings 21 to abut each other, sections of the inner layer 31 and the outer layer 32 of the curtain structure 3 between the abutting elongated strips 34 are folded. Thereafter, the pulling strings 2 are fastened by pulling rightward. (such an operation in relation to the clutching device 11 is conventional). On the contrary, the pulling strings 2 are loosened by pulling leftward, the drawing strings 21 are released to make the folded sections of curtain structure 3 dragged to extend again by its weight.

Because the drawing strings 21 are enclosed inside the curtain structure 3 and not able to be touched, the Roman curtain device is safe to avoid neck-strapping danger even when the kids play or hide near the Roman curtain device because the drawing strings are not in U-shape, i.e. discontinued to not perform a loop.

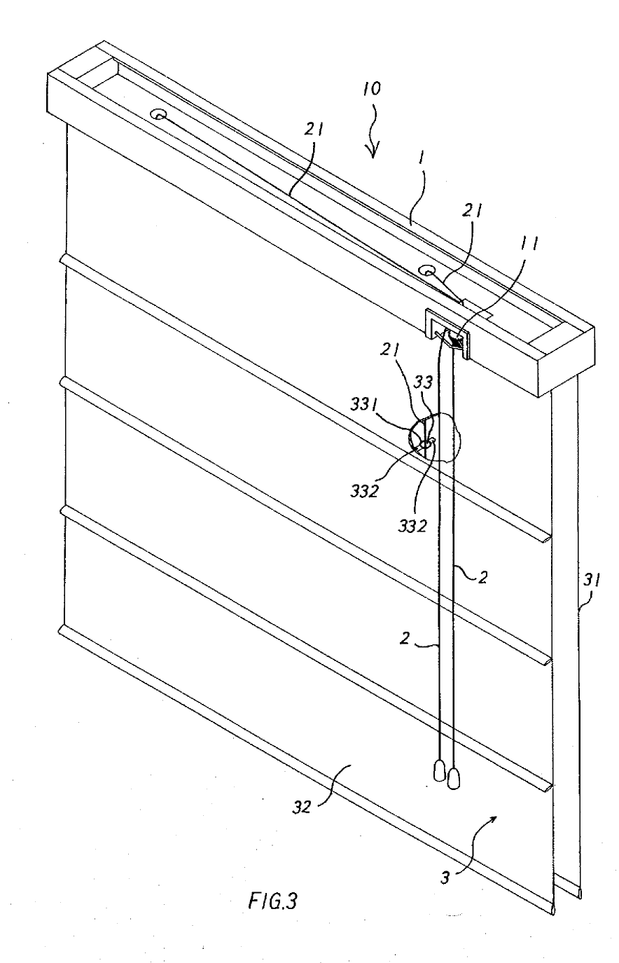

Moreover, with reference to FIG. 3, each of the multiple bridging pieces are made of multiple enhancing rings 331 each with two wing strips 332 attached to the inner layer 31 and outer layer 32 respectively to save material and to decrease weight of the whole curtain structure 3.

Moreover, the inner layer 31 and the outer layer 32 of the curtain structure 3 are performed by half-folded one piece of curtain fabric, wherein distal ends of the curtain fabric are attached to the upper rail 1.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A Roman curtain device comprising at least two pulling strings contacting and passing a clutching device on an upper rail to extend downward to engage with a curtain structure to serve as drawing strings, wherein the improvement of the is that:
the curtain structure is composed of an inner layer and an outer layer, and multiple bridging pieces with at least one through hole connecting between the inner layer and the outer layer.

2. The Roman curtain device as claimed in claim 1, wherein the multiple bridging pieces are multiple elongated strips between the inner layer and the outer layer.

3. The Roman curtain device as claimed in claim 1, wherein the multiple bridging pieces are multiple enhancing rings attached between the inner layer and the outer layer.

4. The Roman curtain device as claimed in claim 3, wherein each of the enhancing rings has two wing strips to attach to the inner layer and the outer layer respectively.

5. The Roman curtain device as claimed in claim 1, wherein inner layer and the outer layer of the curtain structure are performed by a half-folded one-piece curtain fabric.
